(19) United States
(12) Patent Application Publication
(10) Pub. No.: US 2026/0127047 A1
(43) Pub. Date: May 7, 2026

(54) APPLICATION PROGRAMMING INTERFACE SPECIFICATION ENHANCEMENT

(71) Applicant: International Business Machines Corporation, Armonk, NY (US)

(72) Inventors: Koren Ran Lazar, Jerusalem (IL); Matan Vetzler, Givat Shmuel (IL); Guy Uziel, Rishon Lezion (IL); Esther Goldbraich, Kiryat Ata (IL); David Boaz, Bahan (IL); David Amid, Modiin (IL); Ateret Anaby - Tavor, Givat Ada (IL)

(21) Appl. No.: 18/935,791

(22) Filed: Nov. 4, 2024

(51) Int. Cl. G06F 9/54; G06F 8/10; G06F 8/35

(52) U.S. Cl. CPC G06F 9/541; G06F 8/10; G06F 8/35

(57) ABSTRACT

Mechanisms are provided for enhancing an Application Programming Interface (API) specification. The mechanisms receive an existing API specification and an API document that describes the API, and identifies an element candidate in the API document based on a matching of elements in the existing API specification with elements in the API document. The mechanisms determine, for the element candidate, a minimal ancestor based on one or more predetermined minimal ancestor criteria. In addition, the mechanisms generate additional content for the existing API specification which specifies parameter metadata for the element candidate, based on an application of an artificial intelligence (AI) language model (LM) to the minimal ancestor. Moreover, the mechanisms integrate the additional content into the existing API specification to thereby generate an enhanced API specification.

### BACKGROUND

The present application relates generally to a data processing apparatus and method and more specifically to a computing tool and computing tool operations/functionality for enhancing Application Programming Interface (API) specifications through artificial intelligence (AI) model processing of API documents.

An Application Programming Interface (API) is a software interface that connects computers or pieces of software to each other by providing a collection of communication protocols and subroutines used by various programs and computing devices to communicate between them. The API acts as a messenger between pieces of software or computing systems by taking requests from one application and delivery responses from another.

The API can be used to expose data and functionality to external users, such as developers, business partners, and customers. With regard to application development, APIs simplify programming of applications by abstracting the underlying implementation and only exposing the objects or actions that the application developer may need to develop the application. APIs are made up of different parts which act as tools or services that are available to a programmer by performing an API call. The calls of an API are also sometimes referred to as subroutines, methods, requests, or endpoints. An API specification is a document or standard that describes how to build the connection or interface of the API and defines these API calls by explaining how to use and implement these API calls.

APIs are ubiquitous in modern computer applications. Examples of APIs include APIs for various popular applications, such as Twitter API, ChatGPT API, Paypal API, Slack API, Instagram API, and the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for enhancing an Application Programming Interface (API) specification. The method comprises receiving an existing API specification for an API and an API document that describes the API, and identifying an element candidate in the API document based on a matching of elements in the existing API specification with elements in the API document. The method further comprises determining, for the element candidate, a minimal ancestor based on one or more predetermined minimal ancestor criteria. In addition, the method comprises generating additional content for the existing API specification which specifies parameter metadata for the element candidate, based on an application of an artificial intelligence (AI) language model (LM) to the minimal ancestor. Moreover, the method comprises integrating the additional content into the existing API specification to thereby generate an enhanced API specification.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of an Application Programming Interface (API) specification enhancement engine in accordance with one illustrative embodiment;

FIGS. 3A-3D are diagrams illustrating an example operation for determining a minimal ancestor in accordance with one illustrative embodiment;

FIG. 4 is a diagram illustrating an example prompt for In-Context Learning (ICL) by an language model (LM) for generating a structured component for enhancing an API specification in accordance with one illustrative embodiment; and

FIG. 5 presents a flowchart outlining example operations of elements of the present invention with regard to enhancing an API specification in accordance with one or more illustrative embodiments.

### DETAILED DESCRIPTION

The illustrative embodiments provide an improved computing tool and improved computing tool operations/functionality for enhancing Application Programming Interface (API) specifications through artificial intelligence (AI) model processing of API documents. The API specifications are frameworks to standardize the information about APIs in order to provide a broad understanding of how an API behaves and how the API links with other APIs. The API specification sets for a set of rules to deterministically define an API.

The creation of API specifications is an important aspect of modern computing. In many platforms one must first provide an API specification, e.g., an OpenAPI specification, for each API before developers can work with the API. These API specifications can be an important source for function calling by Large Language Models (LLMs) as they concisely represent all the relevant information about a given API. However, creating these API specifications is not a trivial tasks and takes significant time and resources, especially if done manually. A frequent problem that often occurs is that these API specifications become deprecated because online API documentation is continuously updated, yet the API specifications do not keep up with the various changes.

In order to generate reliable Application Programming Interface (API) specifications it is important to provide abundant online API documentation. Thorough documentation serves as a reference for the API and elucidates the intricacies of an API's functionality, parameters, and usage. The API specification fosters a comprehensive understanding of the API, enabling users to employ the API more proficiently. Additionally, well-document APIs facilitate collaboration by promoting standardized integration practices. Online documentation offers insights into authentication methods, error handling, and best practices, reducing the learning curve and streamlining development. Real-world examples and use cases provided in documentation further enhances developers' ability to apply the API effectively.

However, online API documentation may be highly variable in nature, not only with regard to the online API documentation content, but also with regard to the particular document structures utilized, e.g., HyperText Transfer Protocol (HTTP) structure, and the like. This highly variable nature of the API documentation is an impediment to the task of providing thorough API documentation and API specifications using deterministic rule-based algorithms. That is, because the structure and content is variable, the same rules do not apply to all documents and it is impractical to have a set of rules that would cover all possible content and structures of online API documentation.

The illustrative embodiments provide an artificial intelligence (AI) approach to the automatic enhancement of API specifications based on online documentation which is variable in its nature. By “enhancement” what is meant is that an existing API specification is enriched by other documentation so as to make the existing API specification more up-to-date and/or comprehensive in its content. By providing an AI based API specification enhancement mechanism, rather than starting from scratch in building an API specification, the illustrative embodiments streamline the task of providing thorough online API documentation and API specifications by utilizing metadata extracted from the existing API specification, e.g., element candidates, and expand an AI model's prior knowledge using the online API documentation, which reduces the complexity and amount of data needed to generate the enhanced API specification. Moreover, the AI based approach handles situations in which API documentation may lack completeness and may potentially miss some details of the API, or may present information in a non-trivial way that may be overlooked.

The computing tool and computing tool operations/functionality of the illustrative embodiments comprises several components including a scope determination engine that determines the most suitable scope in the online documentation, e.g., a HyperText Transfer Protocol (HTTP) document webpage describing an API, given certain information, e.g., API endpoints and operations, extracted from an API specification. The “scope”, in one or more illustrative embodiments, is a “minimal ancestor” which specifies all the relevant information about a given operation that is required to generate an API specification for that operation. The “minimal ancestor” is identified by traversing the hierarchy of an API document (e.g., the API document may be an HTTP document having a Document Object Model (DOM) tree with HTML elements in an HTML hierarchy) from an identified element, e.g., an HTML element corresponding to a parameter name or parameter title pattern identified in the existing API specification, up the hierarchy until a stopping criterion is satisfied, e.g., an API endpoint is reached, selecting elements as the traversal is performed. The combination of selected elements are then determined to be the minimal ancestor for the original element.

The computing tool and computing tool operations/functionality further comprises a filtering engine that filters the relevant information from the API document content based on a rules engine, a structural data generator comprising one or more language models (LMs) that operate on the API document to extract structural data concerning the API, and an API specification modification engine that integrates the extracted and generated data into an existing API specification. With the mechanisms of the illustrative embodiments, an API specification, API documentation, and a pre-trained LM are provided as input, and the mechanisms of the illustrative embodiments utilize these inputs to generate an enhanced API specification. This may be done on an individual online API document by API document process, or may be performed on a collection of a plurality of online API documents. In some cases, the additions to the API specification may be merged prior to modifying and enhancing the API specification such that the merged data is the basis for the API specification modification.

The enhanced API specification is generated by first determining scope by identifying “minimal ancestors” through extracting significant elements from the existing API specification, such as parameter names, API Uniform Resource Locators (URLs), method types, and the like. These extracted elements are used to find matching text in the API documentation, e.g., matching parameter names, expected parameter headers, and the like, in the HTML elements of the API documentation, e.g., HTML web page, to thereby generate element candidates in the API documentation. For each of these element candidates, a first ancestor which meets a stopping or minimal ancestor selection criterion of a plurality of minimal ancestor selection criteria is found. For example, in some illustrative embodiments, one of the following minimal ancestor selection criteria is found: (1) the ancestor contains an API endpoint element matching the API URL identified from the existing API specification; or (2) the ancestor contains one or more elements of the same parameter name extracted from the API specification. For example, if during the traversal, the first criterion above is not met, i.e., no matching endpoint/API URL is found, the traversal will continue and reach a scope containing multiple operations and ultimately a level where the second criterion is met. The result of traversing the hierarchy of elements in the API documentation until a stopping criterion is met results in one or more candidate “minimal ancestors” for the enhancement of the API specification.

It should be appreciated that each endpoint contains at least one operation, and may contain multiple operations. Each API contains many endpoints. Thus, it is a one-to-many relation. In the case of API documentation webpages, there may be a single operation, a single endpoint, and multiple operations. For each operation, a separate API specification may be independently generated that includes a minimal ancestor. Alternatively, all the API specifications for the various operations may be merged automatically into a single API specification.

Thus, the operation for determining the minimal ancestor may be performed for each of a plurality of the element candidates. These minimal ancestors may be compared to determine which minimal ancestor to use to enhance the API specification by ranking the element candidates and their corresponding minimal ancestors according to one or more minimal ancestor selection criteria. The minimal ancestor selection criteria may include, for example: (1) the number of parameter names from the API specification found in the context of the element candidate, (2) whether an endpoint matching the URL is found, (3) whether the extracted method type was found, (4) whether they contain a “table” element, and (5) the ability to minimize the scope (i.e., filtering out parents of candidates). Identifications of matches may include identification by exact matching or by fuzzy matching, depending on the desired implementation, e.g., an exact or fuzzy match of the URL may be performed to evaluate criterion (2) above.

In some illustrative embodiments, the minimal ancestor selection criteria (1)-(5) may be evaluated in a weighted combination with higher weights being applied to criteria determined to be of greater importance to the evaluation of the minimal ancestor based on the desired implementation. In other illustrative embodiments, a different scoring may be performed for each separate minimal ancestor criterion (1)-(5) and used to compare elements on an individual criterion basis with priority being given to minimal ancestor criterion (1) through (5) in sequence order such that if an element is scored higher for minimal ancestor criterion (1) it will be selected as the minimal ancestor, but if the scores for minimal ancestor criterion (1) are the same across the elements, then a comparison of minimal ancestor criterion (2) may be performed to select a minimal ancestor. It should be appreciated that the minimal ancestor criteria (1)-(5) above are only examples and are not intended to limit the scope of the minimal ancestor criteria that may be utilized. Other minimal ancestor criteria may be used in addition to, or in replacement of, one or more of the above example minimal ancestor criteria to thereby identify the minimal ancestor of an element candidate without departing from the spirit and scope of the present invention.

As noted above, this evaluation of the “minimal ancestor” is performed for each element candidate such that a minimal ancestor is generated for each element candidate. Thereafter, in accordance with one or more illustrative embodiments, the mechanisms, for each minimal ancestor, iterate over the minimal ancestor children and filter them according to a set of filter criteria. In some illustrative embodiments, the filter criteria includes, for example, the following criteria for identifying children that should be kept in the minimal ancestor: (1) whether the child is a “table” element, (2) whether the child is preceded by a parameter header element, (3) whether the child contains any extracted parameter name, and (4) whether the child contains predefined specific phrases indicating a level of importance to the API, e.g., terms or phrases such as “required”, “optional”, etc. Based on the application of the filtering criteria, attributes of the elements are maintained and/or removed. With regard to (1) above, it should be appreciated that in many cases table HTML element in API documentation webpages are parameter tables which contain vital information from the API specification and thus, should be maintained. With regard to (2) and (3) above, the parameter header element and parameter name are signals for a parameter tables and thus, should be maintained. With regard to (4) above, this again is a signal indicating a parameter table. Again, identifications of matches may include identification by exact matching or by fuzzy matching, depending on the desired implementation. Moreover, it should be appreciated that the filter criteria (1)-(4) above are only examples and are not intended to limit the scope of the filter criteria that may be utilized. Other filter criteria may be used in addition to, or in replacement of, one or more of the above example filter criteria to thereby filter children of minimal ancestors without departing from the spirit and scope of the present invention.

The pretrained LM is then applied to the selected and filtered minimal ancestor to generate an API description and structured components of an API description of the API, e.g., a table (e.g., Tab Separated Value (TSV) table) or the like. In the case of a table structural element, the table may comprise rows which represent relevant metadata about a parameter found in the minimal ancestor's content. It should be appreciated that the illustrative embodiments are not limited to generating table type structural elements for API specifications and may instead generate any suitable components of an API description for inclusion in an API specification without departing from the spirit and scope of the present invention, e.g., OpenAPI specification components. Thus, in accordance with one or more illustrative embodiments, these components are structured format components generated from the filtered minimal ancestor, which is unstructured content.

In some illustrative embodiments, in order to apply the pretrained LM, In-Context Learning (ICL) may be utilized in which prompt templates may be utilized and populated with the information associated with the minimal ancestors extracted from the API documentation as the basis for performing the ICL operation. The LM prompt may request that the LM generate a particular structure component for an API specification based on the selected and filtered minimal ancestor as the context for performing the structured component generation, and may specify the type of output that the LM should generate. In other illustrative embodiments, the LM may undergo fine-tuning training using a machine learning training operation and an annotated training dataset that re-trains the pretrained LM specifically for the purpose of enhancing API specifications using minimal ancestor selection and filtering in accordance with the illustrative embodiments.

The API description and structured component generated by the application of the LM to the selected and filtered minimal ancestor is then integrated into the existing API specification. This integration may involve adding the selected and filtered minimal ancestor based API description and structured component to the existing API specification, overriding the metadata of each parameter that is conflicting with the structured component with the information present in the new structured component, and the like. For example, if there is some metadata that was part of the existing API specification, e.g., an example of a parameter, and this was not generated by the LM when generating the new structured component and API description, then this metadata would not be overwritten or deleted. As a result, an enhanced API specification is generated which includes knowledge that is automatically extracted from a large corpus of documentation, e.g., online API documentation, which may be authored by various different entities and may have very different structures and content from one API document to another.

The mechanisms of the illustrative embodiments provide several advantages including the ability to enhance existing API specifications automatically by incorporating knowledge extracted from online documentation. The illustrative embodiments seamlessly integrate API specification details throughout the development lifecycle, resulting in heightened precision and efficiency. The illustrative embodiments mitigate the occurrence of inaccuracies by amalgamating information from independent sources, e.g., the existing API specification and the accessible API documentation. The illustrative embodiments are configured to handle significant variability in the API documentation structures by implementing a deep-learning language model to generalize structural differences. The illustrative embodiments reduce processing time by implementing a rule-based matching algorithm, directing the generation efforts specifically towards the requested API calls. The illustrative embodiments feeding of the API documentation as input for the language model is ensured to be within the content limits of the language model by using the specific relevant scope determination mechanisms so that the LM focuses its effort on the most relevant portions of API documentation and thereby reduce the amount of input to the LM to be within the limits of the LM, which in turn makes the results generated by the LM more accurate.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides computer mechanisms to automatically process a large corpus of API documentation of various content and structures, to extract knowledge and generate descriptions which augment and enhance API specifications. The improved computing tool implements mechanism and functionality, such as an API specification enhancement engine, which cannot be practically performed by human beings either outside of, or with the assistance of, a technical environment, such as a mental process or the like. The improved computing tool provides a practical application of the methodology at least in that the improved computing tool is able to leverage AI language models to generate descriptions of APIs that are then used to enhance existing API specifications to be up-to-date and more comprehensive and accurate regardless of the particular structure and content variability of the source documentation.

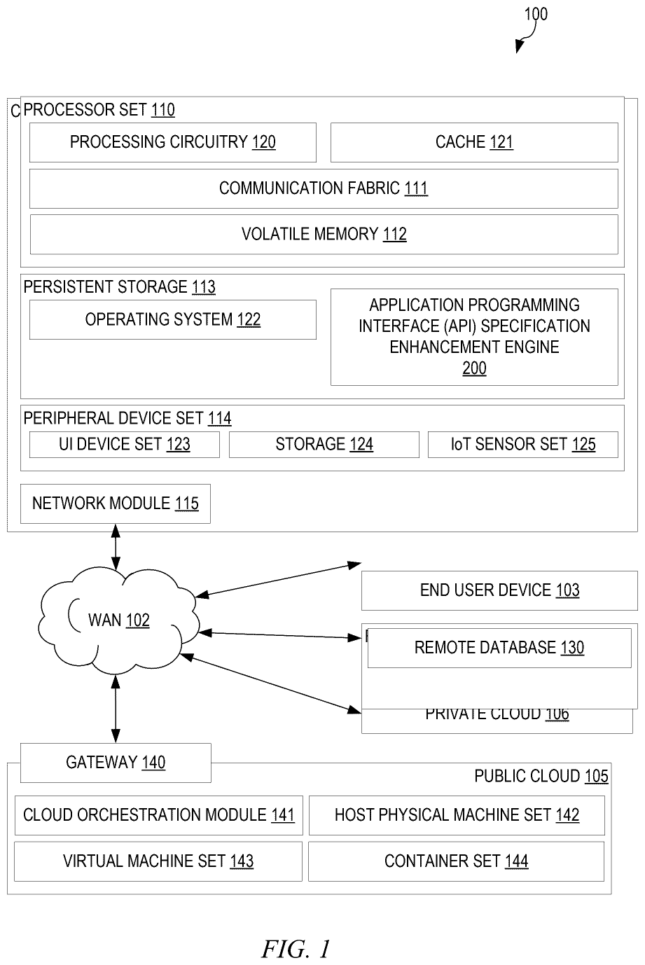

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as API specification enhancement engine 200. In addition to API specification enhancement engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and API specification enhancement engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in API specification enhancement engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in API specification enhancement engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a API specification enhancement engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated enhancement of API specifications based on an AI language model generation of descriptions for inclusion in the API specification. By providing enhancement to an existing API specification, the resulting enhanced API specification provides greater understanding of the intricacies of the API's functionality, parameters, and usage, enabling users to employ the API more proficiently and reducing issues for application developers that utilize the API.

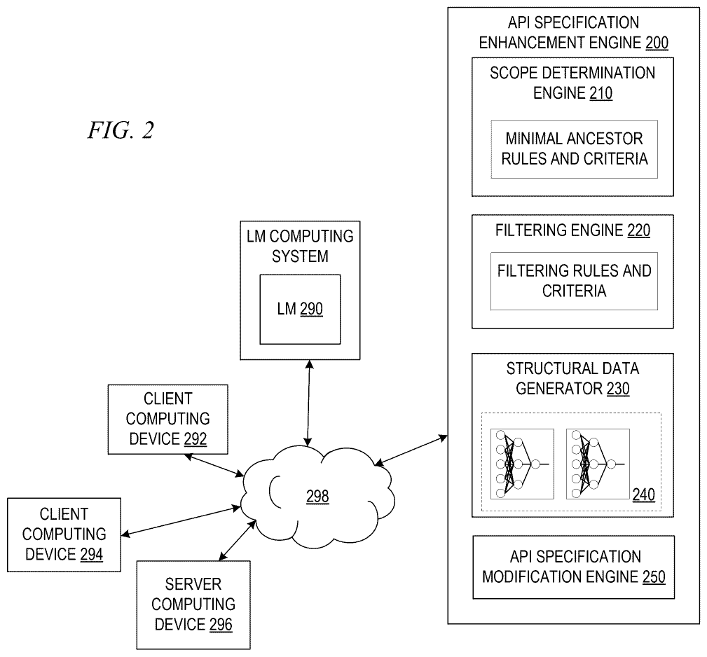

FIG. 2 is an example block diagram illustrating the primary operational components of an Application Programming Interface (API) specification enhancement engine in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to providing an automated AI based computing tool to enhance existing API specifications based on a widely variable corpus of API documentation having variable content and structures, which cannot be practically performed by human beings as a mental process, and which is not directed to organizing any human activity.

As shown in FIG. 2, the API specification enhancement engine 200 includes a scope determination engine 210, a filtering engine 220, a structural data generator 230 comprising one or more language models (LMs) 240, and an API specification modification engine 250. The mechanisms of the illustrative embodiments operate on inputs that include an API specification 260, a corpus of API documentation 270 from one or more various source computing systems 280, and a pre-trained LM 290. It should be appreciated that in some illustrative embodiments, the pre-trained LM 290 is the same LM that is included as one of the one or more LMs 240 of the structural data generator 230. In other illustrative embodiments, the one or more LMs 240 may be fined-tune trained versions of the pre-trained LM 290 which are fine-tuned through machine learning processes and an annotated training dataset to customize the operation of the LM 290 to specifically generate descriptions of APIs from documentation for enhancing API specifications. The API specification enhancement engine 200 may communicate with, and operate in conjunction with, one or more other client and/or server computing systems 292-296 via one or more data networks 298.

With the mechanisms of one or more illustrative embodiments, given an existing API specification 260, a corpus of API documentation 270, and a pre-trained LM 290, the API specification enhancement engine 200 first determines, via the computer logic of the scope determination engine 210, a most suitable scope, e.g., minimal ancestor, in the API documentation given certain information extracted from an API specification, e.g., parameter names, operations, endpoint URLs, etc. In accordance with some illustrative embodiments, the most suitable scope determination is one in which the scope determination engine 210 identifies the minimal ancestors of each API document, where the minimal ancestors define the scope. This scope determination is made in order to reduce the size of the textual content being considered by the LM. That is, LMs have context limits when it comes to their prompts and thus, only a limited amount of contextual information may be provided on which the LM performs its operations. In order to ensure that the context provided to the LM is within these limits, the illustrative embodiments determine minimal ancestors of element candidates in the API documentation, where these minimal ancestors comprise the minimum amount of required elements from the API documentation that should be included in any description of an API in the API specification. Moreover, by focusing the LM operations on a more specific collection of context information, the accuracy of the results generated by the LM is increased, i.e., LM performance is reduced when the amount of context is increased to include potentially unnecessary context information.

The filtering engine 220 operates to filter the relevant information from the API document content based on a rules engine and the identification of the scope by the scope determination engine 210. The filtering engine 220 operates as a type of pre-processor of the minimal ancestors, or scope, determined by the scope determination engine 210. The filtering engine 220 comprises computer logic that iterates over the minimal ancestors in the determined scope to thereby filter out children according to predefined filtering criteria, and thereby generate filtered minimal ancestors.

The filtered minimal ancestors are provided as input to the structural data generator 230 which generates a description and structured components for inclusion in an API specification. For purposes of the present description, it will be assumed that the structure component(s) are table data structures that specify relevant metadata about parameters found in the minimal ancestor's content, although the illustrative embodiments are not limited to only table data structures and any other structured data may be utilized without departing from the spirit and scope of the present invention. The structural data generator 230 may implement one or more language models (LMs) 240 to generate these descriptions and structured components, e.g., table data structures, based on an input of the filtered minimal ancestors. The one or more LMs 240 may be the pre-trained LM 290 in some illustrative embodiments, to which appropriate prompts are submitted to generate the API description and structured component(s), or may be a fine-tuned instances of the pre-trained LM 290 that is fine-tuned for a specific purpose or on specific annotated training data. For example, the one or more LMs 240 may comprise an instance of the LM 290 that is fine-tuned trained, through a machine learning training operation on annotated training data, to specifically generate a description and table structure for specifying parameters of an API from filtered minimal ancestors extracted from one or more API documents.

In the case of the one or more LMs 240 being the pre-trained LM 290, the structural data generator 230 may comprise one or more predefined LM prompts in which the context portion of the LM prompt is populated with the filtered minimal ancestors generated by the scope determination engine 210 and filtering engine 220. The predefined prompt(s) may comprise a fixed portion that specifies to the pre-trained LM 290 what operation it is to perform and the basis upon which that operation is to be performed, e.g., generate an API description from the following context, and a variable portion that specifies the context for performing the operation. The prompt may further specify the way in which the output is to be presented. The resulting prompt generated by the structural data generator 230 may then be input to the pre-trained LM 290 and the results obtained from the pre-trained LM 290 for inclusion in the existing API specification.

The generated description and structured component, e.g., table data structure, are provided to the API specification modification engine 250 which comprises computer logic configured to integrate the generated description and structural data, e.g., table, into an existing API specification. The resulting enhanced API specification may then be made available through one or more server computing devices 296 from which one or more client computing devices 292-294 may access the API specification for development of applications and/or other operations. For example, the enhanced API specification may be deployed in replacement of the previous API specification for use by application developers and other users in a similar way that the original API specification was utilized. However, in the present case, the API specification has been enhanced and thus, provides a greater understanding and up-to-date representation of the API.

As noted above, the enhanced API specification is generated by first determining, by the scope determination engine 210, one or more “minimal ancestors” by extracting significant elements of the API specification 260, such as parameter names, API Uniform Resource Locators (URLs), method types, and the like. These extracted elements are used to find matching text in the API documentation, e.g., matching parameter names, expected parameter headers, and the like, to thereby generate element candidates in the API documentation. That is, the scope determination engine 210 parses the existing API specification 260 and identifies significant elements in the existing API specification. These significant elements may be identified by identifying specific key terms, key phrases, particular tags, and the like, that are specific to API specifications and which are predetermined to represent significant elements for API specifications. The resulting instances of significant elements of the existing API specification may be used to search for similar terms, phrases, and/or tags in API documentation using an exact or fuzzy matching criteria. The API documentation 270 may comprise any suitable corpus of API documentation, such as online (available via the Internet or other wide area network) API documentation or a document repository that stores API documentation for various APIs, and which may be available through local area networks, for example. Those elements of the existing API specification which are matched by instances of key terms, phrases, tags, or the like, in API documentation are considered element candidates. This process can be performed on an individual API document basis, or may be performed across multiple API documents in the API documentation 270. For purposes of illustration, it will be assumed that the process is performed on an individual API document basis, but that results may be merged prior to integration of the result into a modified API specification. In some illustrative embodiments, the API document may be an online API document, such as an HTML webpage or the like, but may be provided in other formats as well depending on the desired implementation.

As previously discussed above, for each of the element candidates identified in the API documentation 270 based on the significant elements extracted from the existing API specification, the scope determination engine 210 identifies a first ancestor element, in the hierarchy of the API documentation 270, of that element candidate which meets one of the following criteria: (1) the ancestor element contains an endpoint element matching the API URL; or (2) the ancestor element contains one or more elements of the same parameter name from the API specification. This process comprises traversing the hierarchical HTML (which has a DOM tree hierarchy) or other hierarchical arrangement of the API documentation 270 to select elements until an element meeting one of the above criteria is encountered. The selected elements together constitute the “minimum ancestor” of the element candidate. This process can be performed for each element candidate found in the API documentation 270.

Once the minimal ancestor(s) for each element candidate are determined, they may be ranked relative to one another using one or more minimal ancestor selection criteria. As noted above, in some illustrative embodiments, the minimal ancestor selection criteria may include, in priority order, for example: (1) the number of parameter names from the API specification found in the context of the element candidate, (2) whether an endpoint matching the URL is found, (3) whether the extracted method type was found, (4) whether they contain a “table” element, and (5) the ability to minimize the scope (i.e., filtering out parents of candidates). Again, identifications of matches may include identification by exact matching or by fuzzy matching, depending on the desired implementation, e.g., an exact or fuzzy match of the URL may be performed to evaluate criterion (2) above.

In some illustrative embodiments, the minimal ancestor selection criteria (1)-(5) may be evaluated in a weighted combination with higher weights being applied to criteria determined to be of greater importance to the evaluation of the minimal ancestor based on the desired implementation. In other illustrative embodiments, a different scoring may be performed for each separate minimal ancestor selection criterion (1)-(5) and used to compare elements on an individual criterion basis with priority being given to minimal ancestor criterion (1) through (5) in sequence order such that if an element is scored higher for minimal ancestor criterion (1) it will be selected as the minimal ancestor, but if the scores for minimal ancestor criterion (1) are the same across the elements, then a comparison of minimal ancestor criterion (2) may be performed to select a minimal ancestor. It should be appreciated that the minimal ancestor criteria (1)-(5) above are only examples and are not intended to limit the scope of the minimal ancestor criteria that may be utilized. Other minimal ancestor criteria may be used in addition to, or in replacement of, one or more of the above example minimal ancestor criteria to thereby identify the minimal ancestor of an element candidate without departing from the spirit and scope of the present invention.

Thus, the scope determination engine 210 determines these “minimal ancestors” which defines an initial scope of the operation for enhancing the API specification. As noted above, this evaluation of the “minimal ancestor” is performed for each element candidate such that a minimal ancestor is generated for each element candidate. These minimal ancestors may then be ranked and one or more of the minimal ancestors may be selected for inclusion in enhancements to the API specification based on the relative rankings. Thereafter, in accordance with one or more illustrative embodiments, for each of the one or more selected minimal ancestors selected based on the relative ranking, the filtering engine 220 iterates over the minimal ancestor children elements in the hierarchy of the minimal ancestor and filters them according to a set of filter criteria. In some illustrative embodiments, the filter criteria includes, for example: (1) whether the child is a “table” element, (2) whether the child is preceded by a parameter header element, (3) whether the child contains any extracted parameter name, and (4) whether the child contains predefined specific phrases indicating a level of importance to the API, e.g., terms or phrases such as “required”, “optional”, etc.

Based on the application of the filtering criteria, attributes of the elements are kept and/or removed. That is, for children that meet one or more of the above filtering criteria (1)-(4), their attributes are maintained as part of the minimal ancestor. For children that do not meet any of the above filter criteria, the attributes of these children are removed from further consideration as part of the minimal ancestor. Again, identifications of matches may include identification by exact matching or by fuzzy matching, depending on the desired implementation. Moreover, it should be appreciated that the filter criteria (1)-(4) above are only examples and are not intended to limit the scope of the filter criteria that may be utilized. Other filter criteria may be used in addition to, or in replacement of, one or more of the above example filter criteria to thereby filter children of minimal ancestors without departing from the spirit and scope of the present invention.

The filtered minimal ancestors generated as a result of the operation of scope determination engine 210 and filtering engine 220 are input to the structural data generator 230 which utilizes the one or more LMs 240 to generate a description and structured component, e.g., table data structure, that specifies the parameters and other API description information that is to be used to enhance the existing API specification. That is, the pretrained LM 290, and/or fine-tuned instance(s) 240 of the pre-trained LM 290, are applied to the filtered minimal ancestors to generate a textual description of the API from the filtered minimal ancestors, and may also generate a structured component, e.g., table data structure where each row represents relevant metadata about a parameter found in the filtered minimal ancestor's content. In some illustrative embodiments, in order to apply the pretrained LM, In-Context Learning (ICL) may be utilized in which prompt templates stored by the structural data generator 230 may be utilized and populated with the context information associated with the filtered minimal ancestors extracted from the API documentation as the basis for performing the ICL operation. In other illustrative embodiments, the LM may undergo fine-tuning training using a machine learning training operation and an annotated training dataset that re-trains the pretrained LM specifically for the purpose of enhancing API specifications.

The description and structured component, e.g., table data structure, generated by the structural data generator 230 is provided as input to the API specification modification engine 250. The API specification modification engine 250 operates to automatically modify the existing API specification to include the automatically generated description and structured component provided by the structural data generator 230. This integration may involve adding the selected and filtered minimal ancestor based API text and structured component to the existing API specification, overriding the metadata of each parameter that is conflicting with the structured component with the information present in the new structured component, and the like. For example, if there is some metadata that was part of the existing API specification, e.g., an example of a parameter, and a conflicting or replacement metadata was not generated by the LMs 240 when generating the new structured component and API text description, then this metadata would not be overwritten or deleted. As a result, an enhanced API specification is generated which includes knowledge that is automatically extracted from a large corpus of documentation, e.g., online API documentation, which may be authored by various different entities and may have very different structures and content from one API document to another.

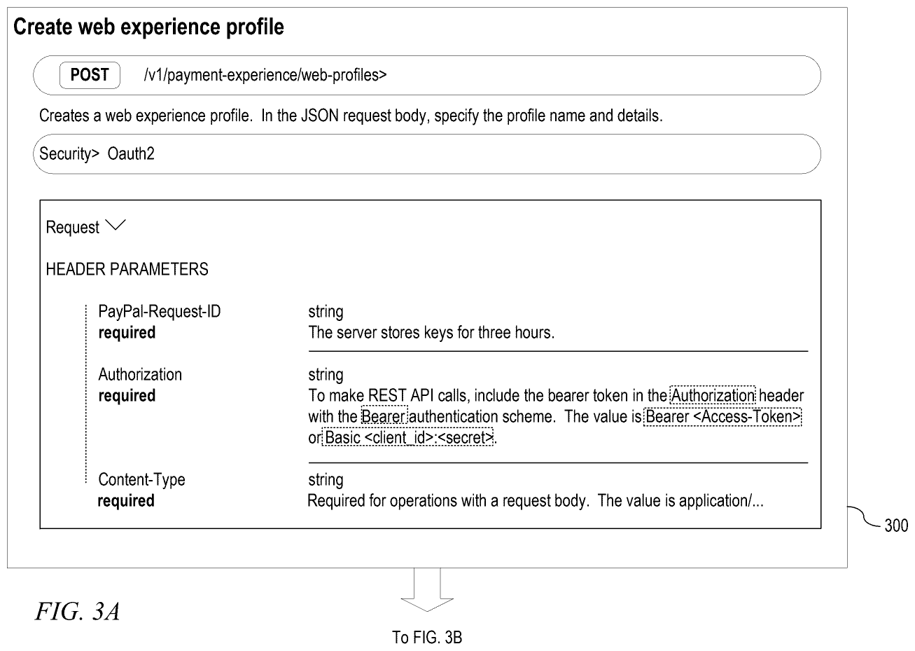

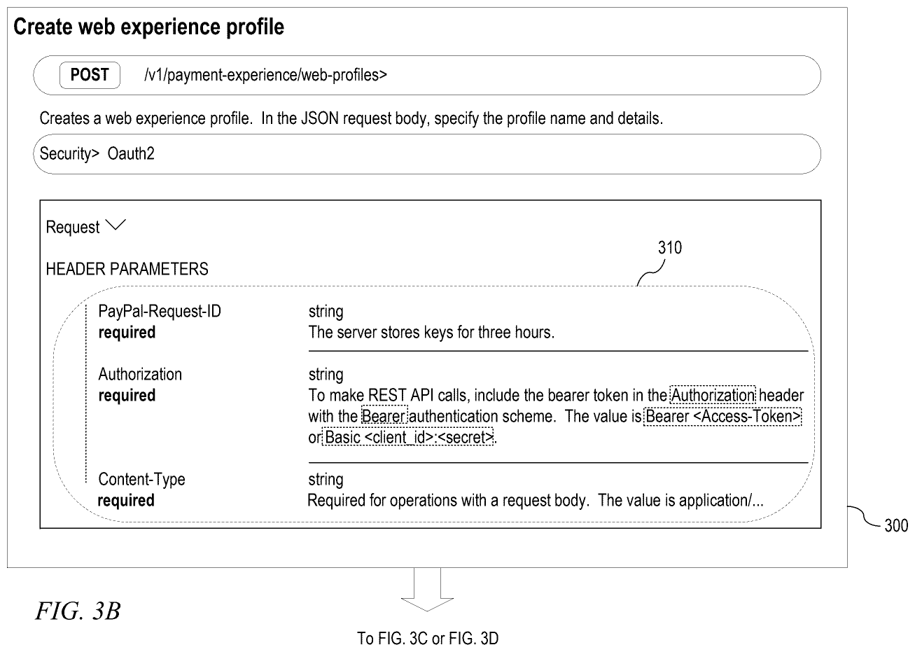

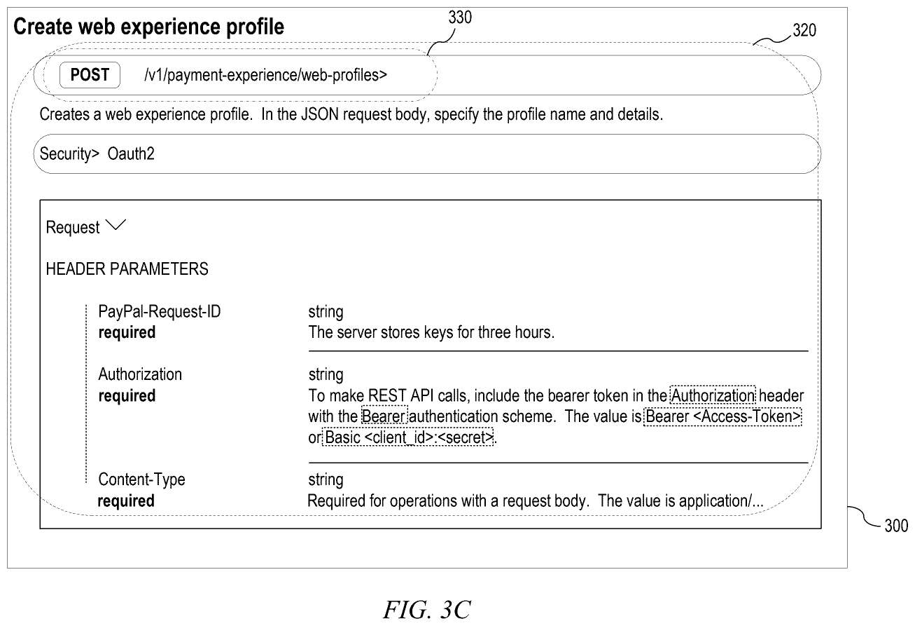

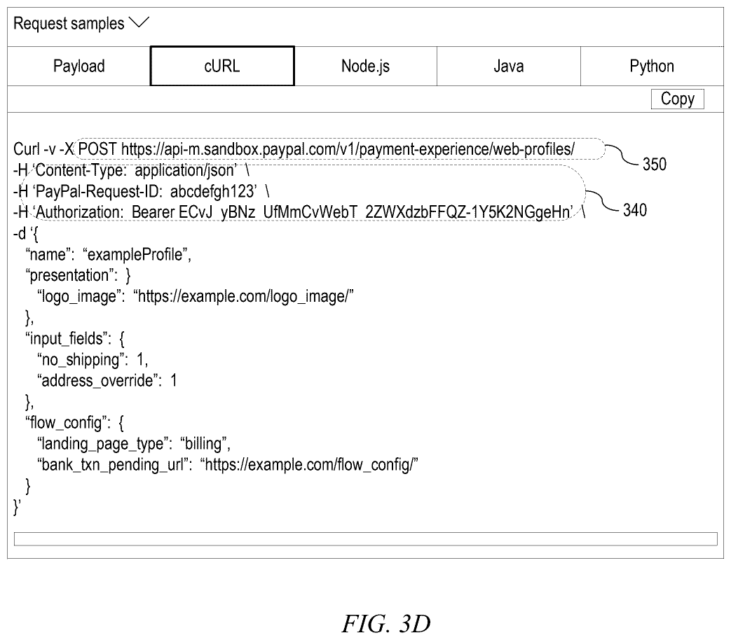

FIGS. 3A-3D are diagrams illustrating an example operation for determining a minimal ancestor in accordance with one illustrative embodiment. As shown in FIGS. 3A-3D, an API document 300 describing an API for creating a web experience profile is provided. In according with the illustrative embodiments, based on an existing API specification, and the identification of significant elements in the existing API specification, one or more corresponding element candidates 310 are found in the API document 300. From the element candidates, for the operation “POST” shown in the API document 300, the API document's hierarchy is traversed to identify the minimum ancestor. To find the minimal ancestor, a first set of “small” candidates are identified according information retrieved from the API specification (e.g., the names of the parameters that are looked for inside the API document 300) and in accordance with prior knowledge about the API document 300 (e.g., API documents tend to contain similar parameter headers such as “parameters”, “query parameters”, “headers”, etc.). In some illustrative embodiments, this may involve identifying parameters by looking at HTML tags and identifying those having text matches to the name of an operation parameter from the given API specification. In addition, this may involve identifying request/response parameter titles by identifying HTML tags whose text matches a predefined regex pattern that captures different phrasings of parameter titles or the like, where there may be two different patterns for the request and the response of the operation.

In this example, the element candidates 310 are shown in the HTML of the API document as elements 310. In the depicted example, the hierarchy is traversed until a stopping criterion is met, e.g., a matching URL to the original “POST” operation is found (see the stopping criterion (1) above) or the ancestor element contains one or more elements of the same parameter name from the API specification (see the stopping criterion (2) above). Thus, if criterion (1) is met, element 330 is reached and the minimal ancestor is selected to be 320. If criterion (2) is met, then elements

Thereafter, the minimal ancestor is filtered to remove unnecessary child elements. As shown in 310, each of the child elements are indicated to be “required” elements in the metadata of the API specification, meaning that these parameters must be included in every request to the API. Therefore, when generating the minimal ancestor these child elements or parameters are not filtered out. If these elements meet a filtering criterion, then they may be maintained as part of the minimal ancestor 320. For those elements that do not meet any of these filter criteria, e.g., the filter criteria (1)-(4) discussed above, those elements may be removed from the minimal ancestor. Thus, each of the depicted child elements are included in the minimal ancestor 320 for the POST operation 330 in this example.

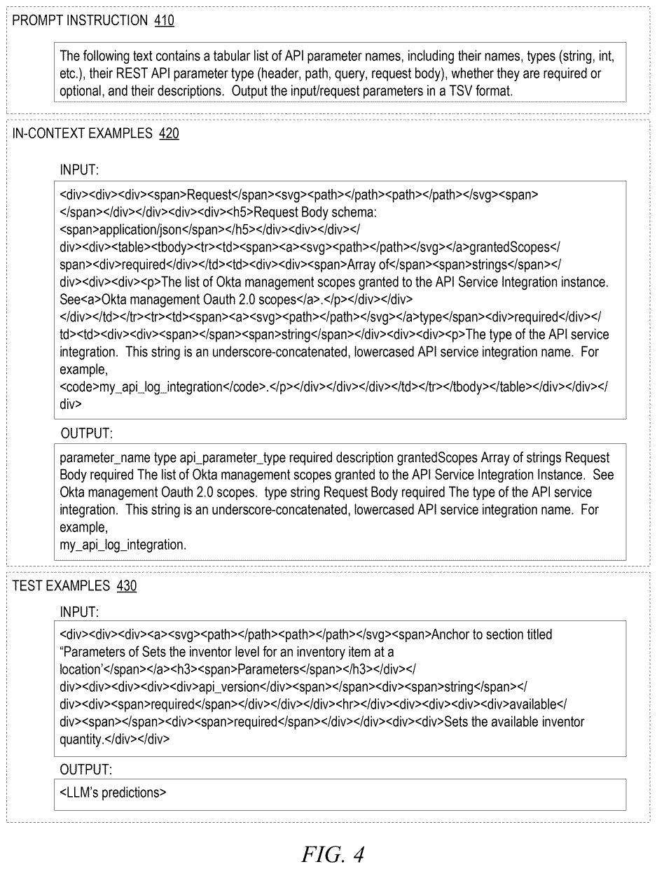

FIG. 4 is a diagram illustrating an example prompt for In-Context Learning (ICL) by an language model (LM) for generating a structured component for enhancing an API specification in accordance with one illustrative embodiment. As shown in FIG. 4, the example includes a prompt instruction 410 which specifies to the LM what the LM is to do, what input format it should expect, and what is the output format that the LM should generate. It also then provides a matching input-output pair before providing the input for inference. In this particular case, the prompt instructs the LM that the context it is being provided is a tabular list of API parameter names and that the tabular list includes certain parameters, e.g., names, types, REST API parameter type, etc. The prompt instruction 410 further specifies that the output is to be the input request parameters in a TSV format. The TSV format is just one of the structured output formats we use. Thereafter, the example shown in FIG. 4 includes the in-context examples 420 and test examples 430. This type of prompt may be input the LM to have the LM generate a TSV table structure from a minimal ancestor which may be provided as an in-context example 420. The LM would then generate the TSV table structure of that minimal ancestor and provide it as a structure for inclusion in the enhanced API specification.

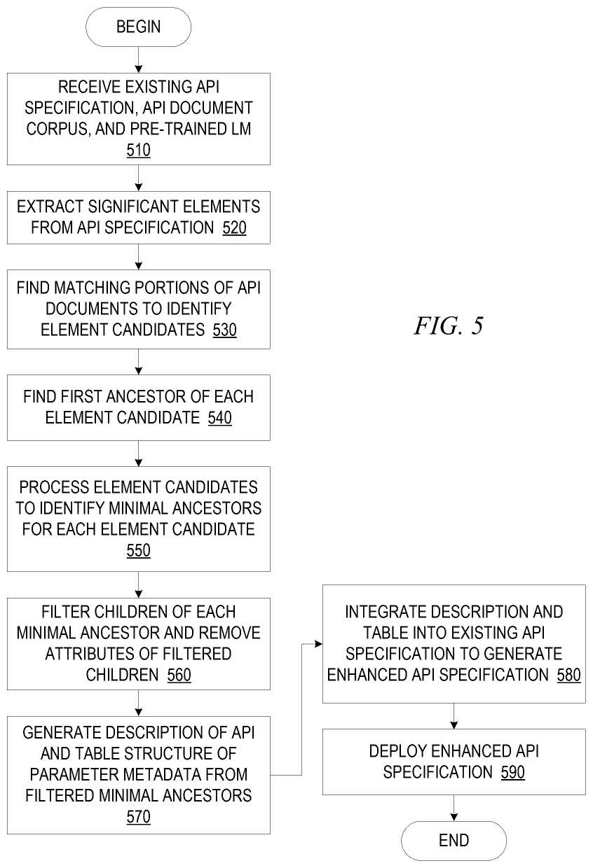

FIG. 5 presents a flowchart outlining example operations of elements of the present invention with regard to enhancing an API specification in accordance with one or more illustrative embodiments. It should be appreciated that the operations outlined in FIG. 5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the improved computing tool in an automated manner.

As shown in FIG. 5, the operation starts by receiving an existing API specification, an identification of the API documentation to be utilized, and a pre-trained LM (step 510). The operation then extracts significant elements from the API specification, e.g., parameter names, API URL, method types, and the like (step 520). Portions of the API documentation are found that match the significant elements to thereby identify element candidates (step 530). A first ancestor is found for each element candidate (step 540). The element candidates are then processed to determining a minimal ancestor for each element candidate (step 550). The minimal candidates are then pre-processed to filter children in accordance with predefined filter criteria and remove the filtered out children's attributes from further consideration (step 560). The filtered minimal ancestors are then processed to generate a description of the API and a table specifying parameter metadata found in the minimal ancestors' content (step 570). The description and table are then integrated into the existing API specification to thereby generate the enhanced API specification (step 580). The enhanced API specification may then be deployed for use by users, such as application developers, when developing applications and/or calling APIs to perform computer operations (step 590). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for enhancing an Application Programming Interface (API) specification, the method comprising:
receiving an existing API specification for an API and an API document that describes the API;
identifying an element candidate in the API document based on a matching of elements in the existing API specification with elements in the API document;
determining, for the element candidate, a minimal ancestor based on one or more predetermined minimal ancestor criteria;
generating additional content for the existing API specification which specifies parameter metadata for the element candidate, based on an application of an artificial intelligence (AI) language model (LM) to the minimal ancestor; and
integrating the additional content into the existing API specification to thereby generate an enhanced API specification.

2. The method of claim 1, further comprising processing the minimal ancestor to filter child elements of the element candidate according to one or more predetermined filter criteria and remove attributes of the filtered child elements to thereby generate a filtered minimal ancestor, and wherein the additional content is generated based on the filtered minimal ancestor.

3. The method of claim 1, wherein the one or more predetermined filter criteria comprises a first filter criterion specifying whether the child element is a table element, a second filter criterion specifying whether the child is preceded by a parameter header element, a third filter criterion specifying whether the child contains any extracted parameter name, and a fourth filter criterion specifying whether the child contains predefined specific phrases indicating a level of importance to the API, wherein if any of the first, second, third, or fourth criterion are matched by a child element, the child element is maintained in the minimal ancestor.

4. The method of claim 1, wherein determining a minimal ancestor comprises traversing a hierarchical structure of the API document from the element candidate upwards along the hierarchical structure until an element meeting at least one of the one or more predetermined minimal ancestor criteria is encountered.

5. The method of claim 4, wherein the one or more predetermined minimal ancestor criteria comprises a first criterion in which an ancestor contains an API endpoint element matching an API Uniform Resource Locator (URL) identified from the existing API specification, and a second criterion in which the ancestor contains one or more elements of a same parameter name extracted from the existing API specification.

6. The method of claim 1, wherein the additional content is at least one of a textual description of the minimal ancestor for inclusion in the existing API specification, or a structured component of the minimal ancestor for inclusion in the existing API specification.

7. The method of claim 6, wherein the additional content is a structured component, and wherein the structured component is a table data structure comprising table elements specifying parameters of the minimal ancestor.

8. The method of claim 1, wherein generating the additional content for the existing API specification comprises generating a language model In-Context Learning (ICL) prompt instructing the AI LM to generate a structured component based on the minimal ancestor.

9. The method of claim 1, wherein integrating the additional content into the existing API specification to generate the enhanced API specification comprises overriding conflicting parameter metadata in the existing API specification with parameter metadata in the additional content.

10. The method of claim 1, further comprising storing the enhanced API specification in replacement of the existing API specification in an API specification repository.

11. A computer program product comprising a computer readable storage medium having a computer readable program stored therein, wherein the computer readable program, when executed in a data processing system, causes the data processing system to:
receive an existing Application Programming Interface (API) specification for an API and an API document that describes the API;
identify an element candidate in the API document based on a matching of elements in the existing API specification with elements in the API document;
determine, for the element candidate, a minimal ancestor based on one or more predetermined minimal ancestor criteria;
generate additional content for the existing API specification which specifies parameter metadata for the element candidate, based on an application of an artificial intelligence (AI) language model (LM) to the minimal ancestor; and
integrate the additional content into the existing API specification to thereby generate an enhanced API specification.

12. The computer program product of claim 11, wherein the computer readable program further causes the data processing system to process the minimal ancestor to filter child elements of the element candidate according to one or more predetermined filter criteria and remove attributes of the filtered child elements to thereby generate a filtered minimal ancestor, and wherein the additional content is generated based on the filtered minimal ancestor.

13. The computer program product of claim 11, wherein the one or more predetermined filter criteria comprises a first filter criterion specifying whether the child element is a table element, a second filter criterion specifying whether the child is preceded by a parameter header element, a third filter criterion specifying whether the child contains any extracted parameter name, and a fourth filter criterion specifying whether the child contains predefined specific phrases indicating a level of importance to the API, wherein if any of the first, second, third, or fourth criterion are matched by a child element, the child element is maintained in the minimal ancestor.

14. The computer program product of claim 11, wherein determining a minimal ancestor comprises traversing a hierarchical structure of the API document from the element candidate upwards along the hierarchical structure until an element meeting at least one of the one or more predetermined minimal ancestor criteria is encountered.

15. The computer program product of claim 14, wherein the one or more predetermined minimal ancestor criteria comprises a first criterion in which an ancestor contains an API endpoint element matching an API Uniform Resource Locator (URL) identified from the existing API specification, and a second criterion in which the ancestor contains one or more elements of a same parameter name extracted from the existing API specification.

16. The computer program product of claim 11, wherein the additional content is at least one of a textual description of the minimal ancestor for inclusion in the existing API specification, or a structured component of the minimal ancestor for inclusion in the existing API specification.

17. The computer program product of claim 16, wherein the additional content is a structured component, and wherein the structured component is a table data structure comprising table elements specifying parameters of the minimal ancestor.

18. The computer program product of claim 11, wherein generating the additional content for the existing API specification comprises generating a language model In-Context Learning (ICL) prompt instructing the AI LM to generate a structured component based on the minimal ancestor.

19. The computer program product of claim 11, wherein integrating the additional content into the existing API specification to generate the enhanced API specification comprises overriding conflicting parameter metadata in the existing API specification with parameter metadata in the additional content.

20. An apparatus comprising:
at least one processor; and
at least one memory coupled to the at least one processor, wherein the at least one memory comprises instructions which, when executed by the at least one processor, cause the at least one processor to:
receive an existing Application Programming Interface (API) specification for an API and an API document that describes the API;
identify an element candidate in the API document based on a matching of elements in the existing API specification with elements in the API document;
determine, for the element candidate, a minimal ancestor based on one or more predetermined minimal ancestor criteria;
generate additional content for the existing API specification which specifies parameter metadata for the element candidate, based on an application of an artificial intelligence (AI) language model (LM) to the minimal ancestor; and
integrate the additional content into the existing API specification to thereby generate an enhanced API specification.
